(19) United States
(12) Patent Application Publication
(10) Pub. No.: US 2010/0198559 A1
(43) Pub. Date: Aug. 5, 2010

(54) REAL TIME MONITORING AND CONTROL OF COMMUNICATIONS NETWORKS AND RADIO FREQUENCY DISTRIBUTION NETWORKS

(75) Inventor: Sam Warren, Mount Airy, MD (US)

Correspondence Address: LAUBSCHER & LAUBSCHER, P.C., 1160 SPA ROAD, SUITE 2B, ANNAPOLIS, MD, 21403, US

(73) Assignee: UNITED STATES HOLDINGS, LLC, Baltimore, MD (US)

(21) Appl. No.: 12/364,874

(22) Filed: Feb. 3, 2009

(51) Int. Cl. G06F 15/00

(52) U.S. Cl. 702/188

(57) ABSTRACT

A system and method for monitoring a communications network having a plurality of wired communication cables is characterized by a central computer and a plurality of remote sensors connected with the cables at spaced locations for sampling data at the locations and providing an indication when a fault occurs. The central computer transmits measurement request signals to each remote sensor. In response to a request, the remote sensor samples data on the network at the unit location and sends a measurement of the sample to the central computer where the measurement is compared with baseline measurements for the location. If the measured data from the unit deviates from the baseline measurement, a fault is indicated.

### FIELD OF THE INVENTION

The present invention relates generally to real time monitoring and control of communications networks and radio frequency distribution networks in tunnels, subways and other underground passage ways.

### BACKGROUND OF THE INVENTION

In order to be able to effectively manage the performance and maintenance of communications networks and radio frequency distribution networks in tunnels, subways and other underground passage ways, workers are required to manually inspect segments of the network for faults. Thus, the networks can be non-operational or operating below acceptable limits for an appreciable time until a fault is located and corrected. In addition the process is hazardous, inconvenient and time consuming because maintenance personnel must inspect each segment of the communications network and/or radio frequency distribution network until the faulty portion is located before any repairs can be made. The present invention was developed to provide automatic monitoring of such systems without requiring personal inspection.

### SUMMARY OF THE INVENTION

According to a primary object of the invention, a system for monitoring a communications network having a plurality of communication cables [SW1] includes a plurality of remote sensors connected with the communication cables at spaced locations for monitoring network data at the locations. Each remote sensor includes a unique identifier so that the location being monitored will be recognized. A central computer is connected with the remote sensors and analyzes data from each sensor. If a fault is detected at any sensor, the computer generates an output signal indicative thereof which may be displayed on a monitor.

The central computer includes a transmitter, a receiver, a comparator, and a storage device such as a memory in which baseline data for each location is stored. The transmitter sends sequential requests for measurement information to each of the remote sensors which in turn send measurement information corresponding to the network data at the location of the sensor to the receiver of the computer. The comparator compares the measurement information from each sensor with baseline data for each sensor and produces a fault signal when the measurement information differs from the baseline information. In this manner, the operator of the monitoring system will be able to quickly detect where a fault in the communication system has occurred.

Each remote sensor includes a receiver for receiving requests for measurement data, a microprocessor for producing the measurement information as a function of the network data at the location, and a transmitter for transmitting measurement information to the central computer.

The communication system is bi-directional and the remote sensors are capable of monitoring network data flowing in both directions. The measurement requests and information transmitted between the remote sensors and the central computer do not interfere with the bi-directional data transmitted through the communications network being monitored.

The invention further relates to a method for monitoring a wired communications network in a tunnel environment such as within a subway system. According to the method, communication cables of the network are tapped at spaced locations and the network data at each tapped location is monitored. Signals corresponding to the monitored network data are compared with baseline data. Where there is a variance in the monitored data from the baseline data, a fault is indicated.

### BRIEF DESCRIPTION OF THE FIGURES

Other objects and advantages of the invention will become apparent from a study of the following specification when viewed in the light of the accompanying drawing, in which:

FIG. 1 is block diagram of the communications network monitoring system according to a preferred embodiment of the invention;

FIG. 2 is a block diagram of a communications network incorporating the monitoring system according to the invention;

FIG. 3 is a detailed block diagram illustrating how a remote sensor of the monitoring system is connected with the communications network being monitored according to one embodiment of the invention; and

FIG. 4 is a flow chart illustrating a preferred method for monitoring a communications network according to the invention.

### DETAILED DESCRIPTION

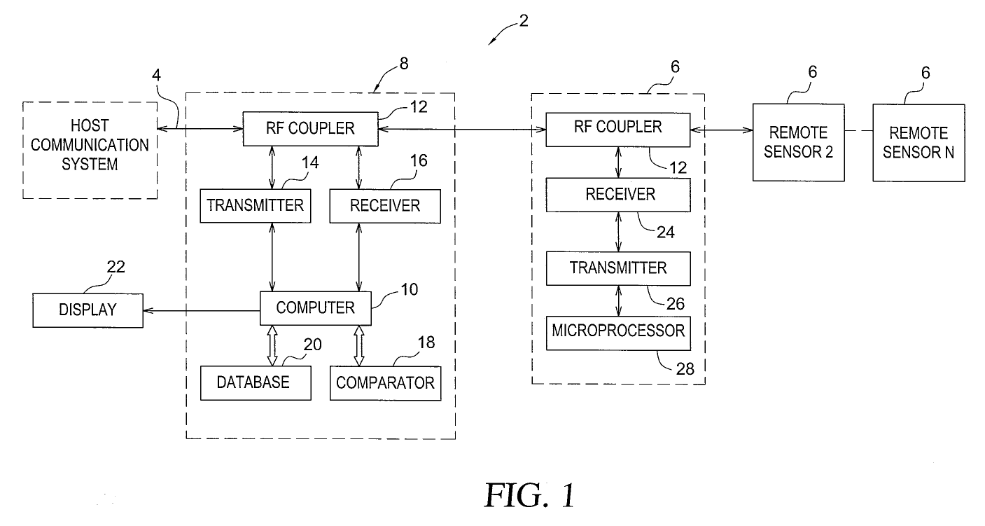

Referring first to FIG. 1, the monitoring system 2 according to a preferred embodiment of the invention will be described. The system is used to monitor the performance of a communication network 4 or a radio frequency (RF) distribution network in a building, subway system or other tunnel environment. The network is a wired network comprising a plurality of cables.

The monitoring system includes a plurality of remote sensors or units 6 which are connected with the communication cables of the network at spaced locations for monitoring network data at each location. The number N of remote sensors is variable in accordance with the size of the network. Each remote sensor has a unique identifier so that the location being monitored can be defined. The remote sensors are connected with an RF controller 8 including a central computer 10 which analyzes data from each unit. The computer produces an output signal when a fault is detected at one of the remote sensors.

The RF controller includes an RF coupler 12 for connection with the communication network, a transmitter 14 for sequentially sending requests for measurement information to each remote sensor and a receiver 16 for receiving the measurement information and measuring the amplitude of the received transmission. The measurement information is delivered to the computer 10. One of the functions of the computer is to serve as a comparator 18 between the incoming data and information stored in a data base 20 for each remote sensor Thus, the computer is operable to compare measurement information from each remote sensor with baseline measurement information for that sensor. The comparator generates a fault output signal when the measurement information differs from the baseline information by a selected order of magnitude. The fault signal is delivered to a display 22. An operator of the monitoring system can thus determine not only when a fault occurs in the network being monitored but also the location of the fault. This facilitates a quick response and repair to the network.

Each remote sensor 6 includes an RF coupler 12, a receiver 24, a transmitter 26, and a microprocessor 28. The RF coupler 12 that lightly couples the primary cable while providing sufficient attenuation for the receiver and the transmitter. The receiver receives requests for measurement information which are generated by the computer and transmitted by the computer transmitter. The microprocessor 28 in each remote sensor produces the measurement information as a function of the network data at the location of the remote sensor. The transmitter 26 in the remote sensor transmits the measurement information to the receiver 16 of the central computer. The frequency of measurement and transmission is controlled by command from the central computer.

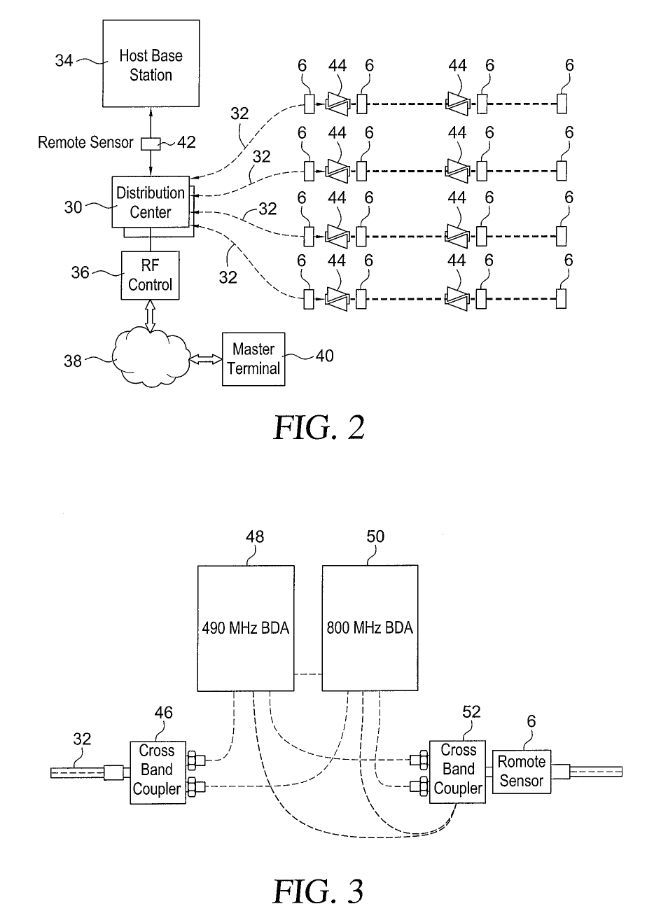

Installation of the monitoring system according to a preferred embodiment of the invention will now be described with reference to FIGS. 2 and 3. The monitoring system is preferably a real time monitoring and control system which includes a plurality of taps at a plurality of interfaces along the communications network and/or radio frequency distribution network. The communications network includes a distribution center 30 having a plurality of communication cables 32 connected therewith. This communications network is interfaced to a host base station 34. A radio frequency (RF) control device 36 is connected with the distribution center. The RF control device is connected with a data network 38 which in turn is connected with a master terminal 40. The master terminal includes the display on which faults are indicated to the operator. A remote sensor 42 can be inserted into the RF path from the host base station 34 to the distribution center. The central computer of the monitoring system may be located in the host base station or at any portion of the infrastructure where access to the data network is available [SW2]

The communication cables 32 of the network comprise coaxial cables, radiating cables, fiber-optic distribution cables and bi-directional amplifiers 44 for boosting the signals or data transmitted thereby. For example, the communication may comprise voice communications over FM radio and digital FM radio via a wired network, typically via co-axial cable. Fire, police and public service operations are typically in the 160 to 870 Megahertz range and are various types of communications on the network.

A plurality are taps is utilized to periodically tap off the signal being transmitted at various spaced intervals along the network. Using a remote sensor 6 at each of a plurality of taps, real time monitoring of the network is accomplished. Each remote sensor contains a unique permanent address or identifier. The receiver and transmitter of the remote sensor use a built-in look up table within the microprocessor which is able to compensate for temperature variations and correct for ambient changes in the surrounding environment, thereby improving accuracy of the network measurement data collected. The period of measurement is controlled to reduce impacts of noise and modulation on the network.

The microprocessor of each remote sensor can be modified by downloading updates and upgrades from the central control computer into the remote sensor.

Network data collected by the plurality of taps is bi-directional and includes both data regarding the performance of the downlink (Base to Mobile) and the uplink (Mobile to Base) of the network transmissions. The communication network shown in FIG. 2 thus includes a plurality of bi-directional amplifiers 44 in each communication line 32. The taps for the remote sensors 6 may be arranged on either side of each bi-directional amplifier or only at one side of each bi-directional amplifier as shown, with an additional unit at the end of each line.

FIG. 3 illustrates an example of the connection of a remote sensor with the communication line 32 in the form of a coaxial cable. A cross-band coupler 46 is connected with the line and has two outputs which are connected with the amplifiers 48, 50 which comprise the bi-directional amplifier 44 shown in FIG. 2. The amplifiers 48, 50 in turn are connected with a second cross-band coupler 52. The remote sensor 6 is connected between the cross-band coupler 52 and the co-axial cable. If desired, a further sensor (not shown) can be connected between the coupler 46 and the co-axial cable. In addition, the bi-directional amplifiers may be omitted if desired.

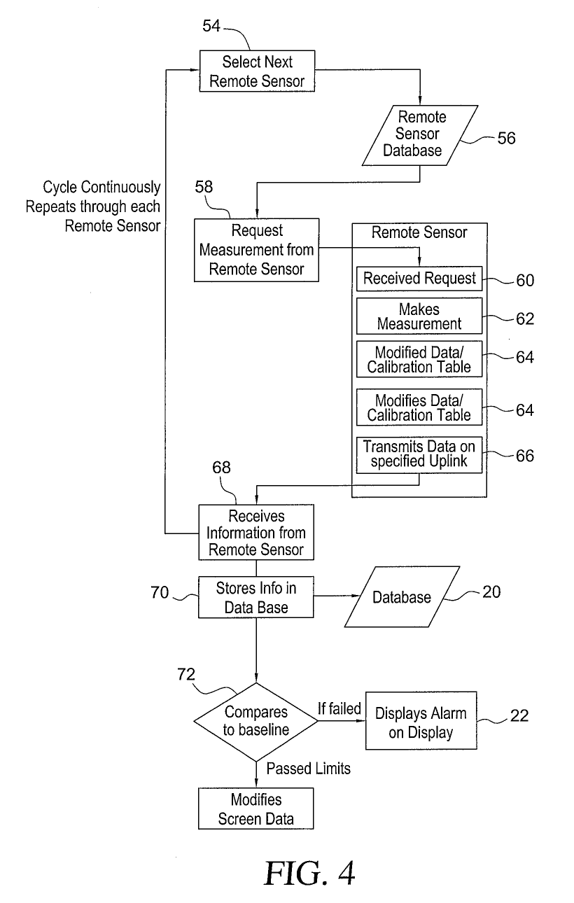

The method for monitoring a communications network using the monitoring system according to the invention will be described with reference to FIG. 4. The central computer cycles through the various remote sensors sequentially. A specific sensor at a given location is selected at step 54 from a database 56 containing the location of all of the remote sensors. A measurement request signal 58 is transmitted to the selected sensor from the transmitter of the central computer. The remote sensor receives the request signal 60, takes a measurement 62 of the data from the network, modifies the measured data using calibration tables 64, and transmits the measurement data 66 to the central computer.

Data collected and measured by the remote sensors may include signal levels and frequencies of the network transmissions at each of the plurality of taps. The measurement frequency may be controlled so that specific operational traffic channels may be monitored or the magnitudes of the monitoring network command frequency may be measured.

The receiver of the central computer receives the measurement data 68 and stores the data 70 in the data base 20 of the computer. The measurement data is compared 72 with baseline data from the data base. If the comparison shows a deviation from the baseline data, a fault or alarm signal is displayed on the display 22.

By responding on radio frequency channels within the uplink band, the losses from the remote sensor may be monitored, recorded, evaluated and compared to prior baseline information in the computer data base to determine that the performance of the uplink.

The system operates in a non-interfering manner with the network. Frequency synthesizers in the receiver and the transmitter of the remote sensor allow for selection of frequencies that will not interfere with the network being monitored. The receiver uses narrow band IF filtering to minimize the impact of carriers operating in adjacent bands.

The microprocessor within each remote sensor averages a number of samples to establish a valid measurement of the signal level. The resolution of this measurement is improved by varying the gain in a synchronous manner with the measurement cycle and providing the appropriate offset to compensate for the induced amplitude change.

Each remote sensor makes measurements and responds with the information requested when polled. Alternatively, the remote sensors may utilize a collision avoidance system that permits them to respond on an event or timed basis.

The microprocessor 28 in each remote sensor stores a calibration table for the receiver 24 and applies these corrections to the measurement made by the receiver when responding to the measurement request.

The system is controlled from the central control computer, for example, a conventional personal computer, which is programmed to manage, analyze, report and display network data being collected regarding performance and maintenance status of the network and to provide instructions regarding control of the network.

The remote sensor is equipped with the capability of passing messages from the computer to other equipment devices that are co-located with the remote sensor. This capability enables the control and monitoring of other equipment devices such as bi-directional amplifiers that are placed in difficult to reach places.

While the preferred forms and embodiments of the invention have been illustrated and described, it will apparent to those of ordinary skill in the art that various changes and modifications may be made without deviating from the inventive concepts set forth above.

What is claimed is:

1. A system for monitoring a communications network having a plurality of wired communication cables, comprising
(a) a plurality of remote sensors connected with said communication cables at spaced locations for monitoring network data at said locations; and
(b) a central computer connected with said remote sensors for analyzing data from said remote sensors and producing an output signal when a fault is detected at one of said remote sensors.

2. A monitoring system as defined in claim 1, wherein each of said remote sensors has a unique identifier.

3. A monitoring system as defined in claim 2, wherein said central computer includes a transmitter for sequentially sending requests for measurement information to each remote sensor and a receiver for receiving said measurement information.

4. A monitoring system as defined in claim 3, wherein said central computer further includes a database containing baseline measurement information for each remote sensor.

5. A monitoring system as defined in claim 4, wherein said central computer includes a comparator for comparing measurement information from each remote sensor with baseline measurement information, said central computer producing said fault signal when said measurement information differs from said baseline information for a remote sensor.

6. A monitoring system as defined in claim 5, wherein each remote sensor includes a receiver for receiving said requests for measurement information from said central computer, a microprocessor for producing said measurement information as a function of network data at said location, and a transmitter for transmitting measurement information to said central computer.

7. A monitoring system as defined in claim 6, wherein said central computer quantitatively measures the RF performance of the signal levels throughout the communications network.

8. A monitoring system as defined in claim 3, wherein said communications system is bi-directional and said remote sensors monitor network data flowing in both directions.

9. A monitoring system as defined in claim 7, wherein the communication cables of the communications system include a plurality of spaced bi-directional amplifiers, said remote sensors being connected with said communications cables adjacent to said bi-directional amplifiers.

10. A monitoring system as defined in claim 4, wherein said requests and said measurement information do not interfere with data transmitted within the communications system.

11. A monitoring system as defined in claim 10, wherein said communications network comprises a radio frequency distribution network.

12. A method for monitoring a communications network having a plurality of wired communication cables, comprising the steps of
(a) tapping the communication cables at spaced locations;
(b) monitoring network data at each of said spaced locations;
(c) comparing the monitored network data with baseline data; and
(d) providing a fault indication when said network data at one of said locations varies from said baseline data.

13. A method as defined in claim 12, wherein said monitoring step occurs sequentially at each of said spaced locations.

14. A method as defined in claim 13, wherein said monitoring step does note interfere with data transmitted within the communications system.

15. A method as defined in claim 14, wherein said monitoring step includes measuring the flow of data at each location.

16. A method as defined in claim 15, wherein the communications system is bi-directional and said monitoring step includes monitoring network data flowing in both directions.

17. A method as defined in claim 16, wherein said communications network comprises a radio frequency network.
